(19) United States
(12) Patent Application Publication
(10) Pub. No.: US 2010/0254035 A1
(43) Pub. Date: Oct. 7, 2010

(54) REAR VIEW MIRROR AND A VEHICLE

(76) Inventor: Tiemen Fahner, Nunspeet (NL)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/746,237

(22) PCT Filed: Dec. 7, 2007
(86) PCT No.: PCT/EP07/63513

§ 371 Date: Jun. 4, 2010

(51) Int. Cl. B60R 1/08

(52) U.S. Cl. 359/872

(57) ABSTRACT

A rear view mirror for a vehicle comprises a mirror surface including at least a proximal portion and a distal portion for a blind spot view. The normal to the mirror surface of the proximal portion is different from that of the distal portion. The length of the distal portion is larger than that of the proximal portion as seen along at least one line extending on the mirror surface in a direction from the proximal to the distal portion. When mounted on a vehicle the distal portion is disposed beyond the proximal portion as seen from the vehicle body to the rear view mirror.

### CROSS-REFERENCE TO RELATED APPLICATION

The present application is a national stage filing of International patent application Serial No. PCT/EP2007/063513, filed Dec. 7, 2007, and published as WO 2009/071130 in English.

### BACKGROUND

The discussion below is merely provided for general background information and is not intended to be used as an aid in determining the scope of the claimed subject matter.

An aspect of the present invention relates to a rear view mirror for a vehicle comprising a mirror surface including at least a proximal portion and a distal portion for a blind spot view, wherein the normal to the mirror surface of the proximal portion is different from that of the distal portion.

Such a rear view mirror is known from NL 7711500. The prior art rear view mirror is intended for use in passenger cars and is provided with a distal portion for a blind spot view. A blind spot is typically present next to the vehicle in case of using a mirror having a flat mirror surface which is oriented such that it gives a view on the rear traffic only. This means, for example, that a driver has to look over his shoulder carefully before changing a lane. The prior art rear view mirror as mentioned above includes a distal portion which provides a better view on the blind spot, which helps the driver to drive more safely, especially when wishing to overtake.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the present invention aims to provide a rear view mirror with improved viewing.

For this purpose the length of the distal portion is larger than that of the proximal portion as seen along at least one line extending on the mirror surface in a direction from the proximal to the distal portion.

Due to these features a bigger part of the mirror surface of the rear view mirror is used for providing a view on the blind spot. As a consequence, a smaller part of the mirror surface is used for providing a view on the area behind the vehicle. In practice, however, a relatively smaller proximal portion does not adversely affect viewing, because another vehicle being at a relatively large distance behind the vehicle has small dimensions as seen in the rear view mirror. A small image of the vehicle as seen in a relatively large proximal portion of the rear view mirror, which is the case in prior art rear view mirrors, means inefficient use of the mirror surface of the proximal portion since a large part of the proximal portion shows a view on the areas next to the sides of the vehicles of the rear traffic. Therefore, the proximal portion may be relatively small.

A relatively wide distal portion provides a broad view on the blind spot, without the necessity of a convex mirror surface of the distal portion which might distort the view and cause a passing vehicle passing at high speed through the view of the distal portion. It is even possible to direct the distal portion in such a way that it is no longer necessary for the driver to look in sideward direction (over his shoulder) in order to see whether another vehicle is in the area, which is normally called the blind spot. Therefore, the driver can concentrate on the traffic before him better.

In one embodiment the mirror surface of at least one of the proximal portion and the distal portion is substantially flat, since this provides a non-distorted image to the driver. However, entirely or partially non-flat mirror surfaces are not excluded. It is, for example, possible to apply a narrow convex mirror surface at the location where the edge portions of the proximal and distal portions converge so as to create a gradual transitional mirror surface between said portions. This enables the driver to follow a passing vehicle gradually. In principle, a passing vehicle can be followed by the eyes without turning the head or with negligible turning the head. In an alternative embodiment the mirror surface of both proximal and distal portions are substantially flat.

The proximal portion and the distal portion may be tiltable with respect to each other. This improves viewing since the distance between the driver's eyes and the rear view mirror may vary per vehicle type, and that distance is also dependent on the length of the upper body of a driver. In one embodiment, the rear view mirror provides the driver the possibility to change the orientation of the distal and proximal portions from the inner side of the vehicle.

An aspect of the invention also relates to a vehicle comprising a vehicle body and a rear view mirror comprising a mirror surface including at least a proximal portion and a distal portion for a blind spot view, wherein the normal to the mirror surface of the distal portion is different from that of the proximal portion, and wherein the rear view mirror is mounted to the vehicle body such that the distal portion is disposed beyond the proximal portion as seen from the vehicle body to the rear view mirror, wherein the length of the distal portion is larger than that of the proximal portion as seen along at least one line extending on the mirror surface in a direction from the vehicle body to the rear view mirror.

### BRIEF DESCRIPTION OF THE DRAWINGS

Aspects of the invention will hereafter be elucidated with reference to a very schematic drawing illustrating an embodiment of the invention by way of example.

FIG. 1 is a very schematic plan view of a vehicle which is provided with an embodiment of a rear view mirror.

FIG. 2 is a part of the view of FIG. 1 on enlarged scale.

FIG. 3 is a schematic perspective view of the embodiment of the rear view mirror of FIGS. 1 and 2.

### DETAILED DESCRIPTION OF THE ILLUSTRATIVE EMBODIMENTS

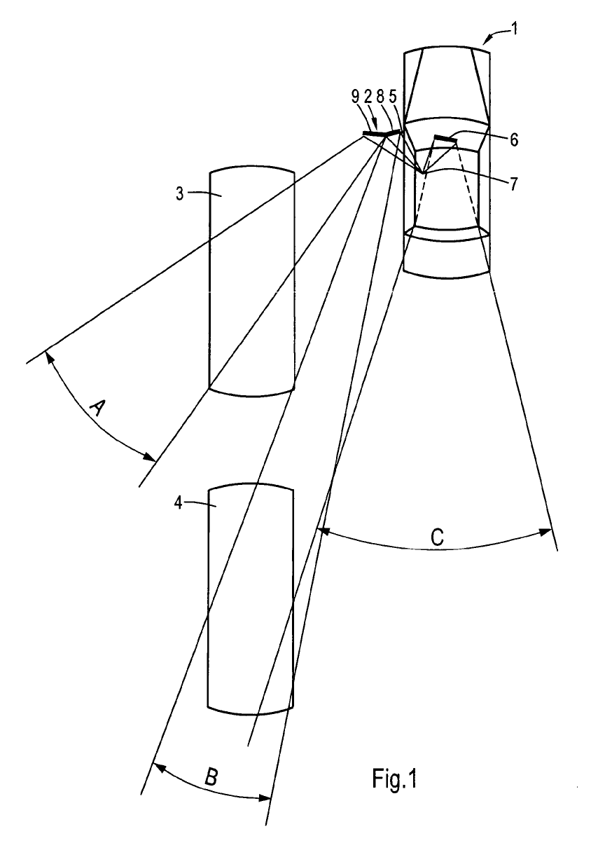

FIG. 1 shows a vehicle 1 including an embodiment of a rear view mirror 2 according to the invention, a first passing vehicle 3 and a second passing vehicle 4. The rear view mirror 2 is mounted to a vehicle body 5 of the vehicle 1. The vehicle 1 drives on a right driving lane, and the first passing vehicle 3 and the second passing vehicle 4 drive on a left driving lane extending parallel to the right driving lane. FIG. 1 illustrates a situation in which the first passing vehicle 3 and the second passing vehicle 4 are passing the vehicle 1.

The vehicle 1 is also provided with an internal rear view mirror 6, and the eyes of a driver are illustrated by a viewpoint 7 as shown in FIG. 1.

The embodiment of the rear view mirror 2 includes a mirror surface which is provided with a proximal portion 8 and a distal portion 9. It is mounted to the vehicle body 5 in such a way that the distal portion 9 is disposed beyond the proximal portion 8 as seen from the vehicle body 5 to the rear view mirror 2. The distal portion 9 is suitable for a view on a blind spot. This means that the normal to the mirror surface of the proximal portion 8 is different from that of the distal portion 9. More specifically, the angle between a line extending in longitudinal direction of the vehicle 1 and the normal to the mirror surface of the distal portion 9 is smaller than that between the line and the normal to the mirror surface of the proximal portion 8 as seen from above to the vehicle 1, in the case when both the proximal portion 8 and the distal portion 9 form an acute angle with respect to the longitudinal line.

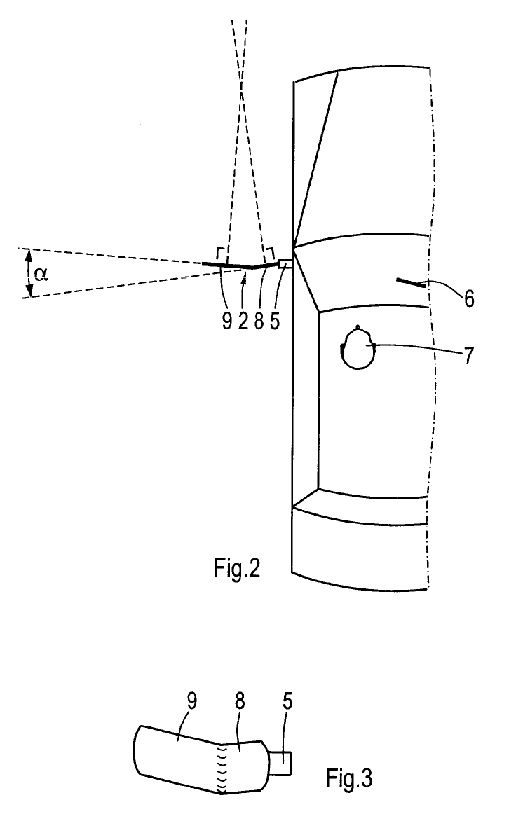

FIG. 2 illustrates that lines along the normal to the proximal portion 8 and along the normal to the distal portion 8 have different directions. The indicated angle α may be about 10°, for example, but a may be smaller or larger, depending on the dimensions of the vehicle, driver, and the like.

As seen in a direction from the vehicle body 5 to the rear view mirror 2, i.e. following a virtual horizontal line extending on the mirror surface of the proximal and the distal portions 8, 9, the length of the distal portion 9 is larger than that of the proximal portion 8. In other words the distal portion 9 provides a wider mirror surface than the proximal portion 8. In the embodiment shown in FIG. 3 the ratio of the widths of the proximal portion 8 and the distal portion 9 is about 1:2, but other ratios higher than 1 are conceivable.

In the embodiment shown in FIG. 1 the mirror surface of the proximal portion 8 and the distal portion 9 are substantially flat. This means that the driver can see the first and second passing vehicles 3, 4 in non-distorted shape. FIG. 1 also shows that the vehicles 3, 4 can be followed by means of the internal rear view mirror 6 via the proximal portion 8 of the externally mounted rear view mirror 2 and finally by means of the distal portion 9 thereof.

Furthermore, FIG. 1 illustrates that the first passing vehicle 3 drives within a distal portion view area or a blind spot area A, and the second passing vehicle 4 drives partly within a proximal portion view area B and also partly within a view area C of the internal rear view mirror 6. It is noted that in case of an entirely flat mirror surface of both the proximal and distal portion there is a blind spot area left between the distal portion view area A and the proximal portion view area B. In practice, however, the orientation of the proximal portion 8 and the distal portion 9 are such that this blind spot area is small with respect to the dimensions of passing vehicles 3, 4. Moreover, converging edge portions of the proximal portion 8 and the distal portion 9 in the region where both portions 8, 9 are adjacent to each other may be shaped in such a way that there is a gradual transition of the mirror surface of the proximal 8 and distal portion 9 so as to minimize the blind spot area, for example by applying a local transitional convex shape.

In one embodiment, the proximal portion 8 and the distal portion 9 are tiltable with respect to each other. This can be achieved, for example, by applying electric motors associated with the proximal and distal portions, which electric motors can be operated by the driver from the inner side of the vehicle 1.

From the foregoing, it will be clear that the invention provides a rear view mirror which significantly improves rearward viewing.

The invention is not limited to the example shown in the drawings and described hereinbefore, which may be varied in different manners within the scope of the claims and their technical equivalents. For example, the rear view mirror is not restricted to passenger cars, but is also suitable for other vehicles, such as heavy-duty vehicles and the like.

1. A rear view mirror for a vehicle comprising a mirror surface including at least a proximal portion and a distal portion for a blind spot view, wherein a normal to the mirror surface of the proximal portion is different from that of the distal portion, wherein a length of the distal portion is larger than that of the proximal portion as seen along at least one line extending on the mirror surface in a direction from the proximal to the distal portion.

2. The rear view mirror according to claim 1, wherein the mirror surface of at least one of the proximal portion and the distal portion is substantially flat.

3. The rear view mirror according to claim 2, wherein the proximal portion and the distal portion are tiltable with respect to each other.

4. A vehicle comprising a vehicle body and a rear view mirror comprising a mirror surface including at least a proximal portion and a distal portion for a blind spot view, wherein the normal to the mirror surface of the distal portion is different from that of the proximal portion, and wherein the rear view mirror is mounted to the vehicle body such that the distal portion is disposed beyond the proximal portion as seen from the vehicle body to the rear view mirror, wherein a length of the distal portion is larger than that of the proximal portion as seen along at least one line extending on the mirror surface in a direction from the vehicle body to the rear view mirror.

5. The vehicle according to claim 4, wherein the mirror surface of at least one of the proximal portion and the distal portion is substantially flat.

6. The vehicle according to claim 5, wherein the proximal portion and the distal portion are tiltable with respect to each other.

7. The vehicle according to claim 4, wherein the proximal portion and the distal portion are tiltable with respect to each other.

8. The vehicle according to claim 1, wherein the proximal portion and the distal portion are tiltable with respect to each other.
